(19) United States
(12) Patent Application Publication
(10) Pub. No.: US 2025/0086506 A1
(43) Pub. Date: Mar. 13, 2025

(54) INFORMATION SELECTION SYSTEM, INFORMATION SELECTION METHOD, AND INFORMATION SELECTION PROGRAM

(71) Applicant: MIZUHO RESEARCH & TECHNOLOGIES, LTD., Tokyo (JP)

(72) Inventors: Takeshi NAGATA, Tokyo (JP); Kosuke TAKEDA, Tokyo (JP); Hidemasa MAEKAWA, Tokyo (JP); Chihiro SEKO, Tokyo (JP); Hiroshi KOIZUMI, Tokyo (JP); Makiko SUITANI, Tokyo (JP); Yuya NEMOTO, Tokyo (JP); Daiki HASHIMOTO, Tokyo (JP); Yuji MORI, Tokyo (JP); Yuki TAMAGAKI, Tokyo (JP); Kohei IWABUCHI, Tokyo (JP); Kenta KONAGAYOSHI, Tokyo (JP); Taishi SHINOBU, Tokyo (JP)

(21) Appl. No.: 18/727,222

(22) PCT Filed: Dec. 26, 2022
(86) PCT No.: PCT/JP2022/047953

§ 371 Date: Jul. 8, 2024

(30) Foreign Application Priority Data
Jan. 11, 2022 (JP) 2022-002565

(51) Int. Cl. G06N 20/00

(52) U.S. Cl. CPC G06N 20/00

(57) ABSTRACT

Provided are an information selection system, an information selection method, and an information selection program for efficiently and appropriately selecting information for use in information processing. A control unit of an assistance server generates a plurality of analysis models, using one or more pieces of information among information constituted by a plurality of pieces of training data, and calculates the accuracy of each of the analysis models. The control unit assigns distribution values according to each accuracy to information used for generating the analytical models, calculates statistics of the distribution values, for each piece of information used for generating the analytical models, and selects, using the statistics, information for use in generating the analytical models.

### TECHNICAL FIELD

The present disclosure relates to an information selection system, an information selection method, and an information selection program for selecting information that are used for information processing.

### BACKGROUND ART

A learning process may use a stepwise method to select variables used in learning. The stepwise method sequentially adds or removes variables one by one (for example, see Patent Literature 1). The technique described in this document selects explanatory variables included in a multiple regression model from a time series database in a process state prediction method. The time series database stores time history data of multiple process variables that indicate the operating status of the process. In this case, after narrowing down the explanatory variables using the stepwise method, explanatory variables that exhibit an influence opposite to that of the actual phenomenon are excluded by checking whether the partial regression coefficients of the narrowed-down explanatory variables are positive or negative.

### CITATION LIST

### Patent Literature

Patent Literature 1: Japanese Laid-Open Patent Publication No. 2012-128800

### SUMMARY OF INVENTION

### Technical Problem

When there are many variables, the number of trials will be significantly large, resulting in a long calculation time.

### Solution to Problem

In one general aspect, an information selection system includes a control unit that selects information to be used to create an analytical model. The control unit is configured to create multiple analytical models using a subset of pieces of information that include multiple pieces of training data, and calculate an accuracy of each of the analytical models, assign a distribution value corresponding to each accuracy to pieces of information used to create the analytical models, calculate a statistical value of the distribution value for each of the pieces of information used to create the analytical models, and select, using the statistical values, information to be used to create the analytical models.

### BRIEF DESCRIPTION OF DRAWINGS

FIG. 1 is an explanatory diagram of an information selection system according to a first embodiment.

FIG. 2 is an explanatory diagram of the hardware configuration of the first embodiment in the information selection system shown in FIG. 1.

FIG. 3 is an explanatory diagram of a process procedure of the first embodiment of the information selection system shown in FIG. 1.

FIG. 4 is an explanatory diagram of a variable table of the first embodiment in the process procedure shown in FIG. 3.

FIG. 5 is an explanatory diagram of a variable table of the first embodiment following FIG. 4.

FIG. 6 is an explanatory diagram of a process procedure according to a second embodiment, which is performed in place of a part of the process procedure shown in FIG. 3.

FIG. 7 is an explanatory diagram of nodes of a self-organizing map (SOM) of the second embodiment in the process procedure shown in FIG. 6.

FIG. 8 is an explanatory diagram of a variable table of the second embodiment in the process procedure shown in FIG. 6.

FIG. 9 is an explanatory diagram of a process procedure of the second embodiment in the process procedure shown in FIG. 6.

FIG. 10 is an explanatory diagram of a process procedure of the second embodiment in the process procedure shown in FIG. 9.

FIG. 11 is an explanatory diagram of a distance table of the second embodiment in the process procedure shown in FIG. 10.

FIG. 12 is an explanatory diagram of a process procedure of the second embodiment in the process procedure shown in FIG. 9.

FIG. 13 is an explanatory diagram of a process procedure of the second embodiment in the process procedure shown in FIG. 12.

FIG. 14 is an explanatory diagram of a process procedure of the second embodiment in the process procedure shown in FIG. 12.

FIG. 15 is an explanatory diagram of a process procedure of the second embodiment in the process procedure shown in FIG. 9, in which part (a) illustrates arrangement of pieces of input data, part (b) illustrates addition of a new node, and part (c) illustrates update of existing nodes.

FIG. 16 is an explanatory diagram of a process procedure according to a third embodiment, which is different from the process procedure shown in FIG. 9.

FIG. 17 is an explanatory diagram of another example of a process procedure relating to the process procedure shown in FIG. 16.

FIG. 18 is an explanatory diagram of another example of a process procedure different from the process procedure shown in FIG. 9.

FIG. 19 is an explanatory diagram of a process procedure of another example in the process procedure shown in FIG. 18, in which part (a) illustrates arrangement of pieces of input data, part (b) illustrates addition of a new node, and part (c) illustrates update of existing nodes.

FIG. 20 is an explanatory diagram of distances between nodes in another example relating to the process procedure shown in FIG. 6.

FIG. 21 is an explanatory diagram of a process procedure of a comparative example.

FIG. 22 is an explanatory diagram of a process procedure of the comparative example relating to FIG. 21.

FIG. 23 is an explanatory diagram of a process procedure of the comparative example following FIG. 22.

FIG. 24 is an explanatory diagram of a process procedure of the comparative example following FIG. 23.

### DESCRIPTION OF EMBODIMENTS

In this specification, “at least one of A and B” should be understood to mean “only A, only B, or both A and B.”

### REFERENCE SIGNS LIST

### First Embodiment

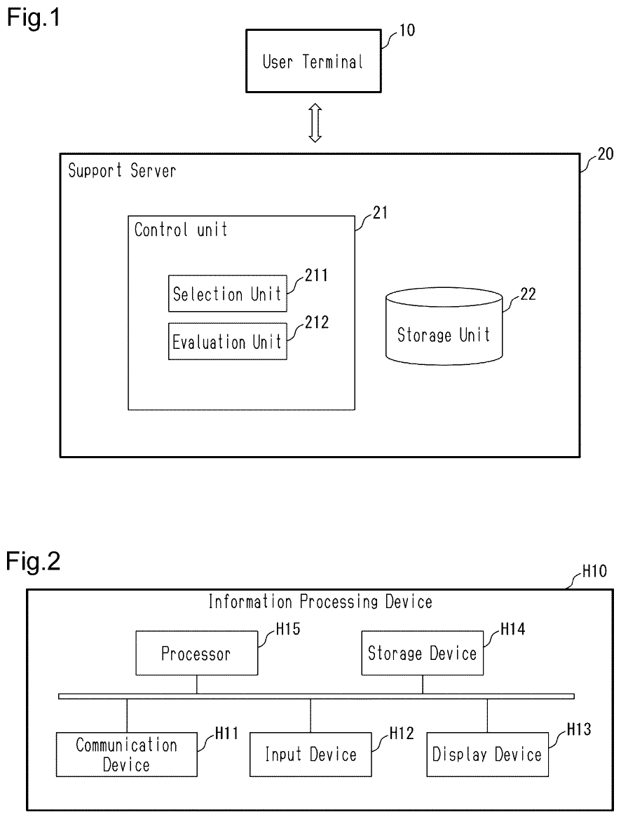

Referring to FIGS. 1 to 5, an information selection system, an information selection method, and an information selection program according to an embodiment will now be described. In this embodiment, learning is repeated by randomly selecting variables (information), and variables are sequentially added and removed to determine the effectiveness of the variables.

As shown in FIG. 1, the information selection system of this embodiment uses a user terminal 10 and a support server 20.

### Hardware Configuration Example

FIG. 2 is an example of the hardware configuration of an information processing device H10, which functions as the user terminal 10, the support server 20, and/or the like.

The information processing device H10 includes a communication device H11, an input device H12, a display device H13, a storage device H14, and a processor H15. This hardware configuration is merely an example, and the information processing device H10 may include other hardware.

The communication device H11 is an interface, such as a network interface or a wireless interface, which establishes communication paths with other devices and performs data transmission/reception.

The input device H12 receives input from a user or the like and may be a mouse or a keyboard, for example. The display device H13 may be a display, a touch panel, and/or the like that displays various information.

The storage device H14 stores data and various programs for executing various functions of the user terminal 10 or the support server 20. Examples of the storage device H14 include ROM, RAM, and hard disk.

The processor H15 controls processes of the user terminal 10 or the support server 20 (for example, the process of a control unit 21 described below) using programs and data stored in the storage device H14. Examples of the processor H15 include a CPU and an MPU. The processor H15 loads the programs stored in the ROM or the like into the RAM and performs various processes corresponding to various types of processing. For example, when the application program of the user terminal 10 or the support server 20 is started, the processor H15 starts a process for performing various types of processing described below.

The processor H15 is not limited to one that performs software processing on all processes executed by itself. For example, the processor H15 may include a dedicated hardware circuit (for example, an application specific integrated circuit “ASIC”) that executes at least part of the processes executed by itself. More specifically, the processor H15 may be any of the following.
(1) One or more processors running on computer programs (software).
(2) One or more special-purpose hardware circuits that executes at least some of the processes.
(3) Circuitry including a combination of the above elements.

The processor includes a CPU and a memory such as a RAM and a ROM. The memory stores program codes or instructions configured to cause the CPU to execute processes. Memory or computer-readable media includes any available media that can be accessed by a general purpose or special purpose computer.

### Functions of Information Processing Devices

Referring to FIG. 1, the functions of the user terminal 10 and the support server 20 are now described.

The user terminal 10 is a computer terminal used by a user of this system.

The support server 20 is a computer system that selects variables to be used in information processing. This support server 20 includes a control unit 21 and a storage unit 22. In this example, machine learning is performed as information processing.

The control unit 21 performs processes (processes including a selection stage, an evaluation stage, and the like) to be described below. The control unit 21 may function as a selection unit 211 and an evaluation unit 212, for example, by executing the information selection program for the above processes.

The selection unit 211 performs the process of selecting variables to be used in information processing.

The evaluation unit 212 performs the process of calculating the accuracy of an analytical model that uses selected variables. Specifically, the evaluation unit 212 creates an analytical model by machine learning, and calculates a prediction error of this analytical model as an accuracy.

The storage unit 22 records information (input data) used for information processing such as machine learning. The input data is recorded in the storage unit 22 when data for information processing is obtained. Input data includes vectors including multiple pieces of element data having different dimensions. For example, input data may be training data including different types of explanatory variables and (one type of) objective variables.

### Backward Elimination Method

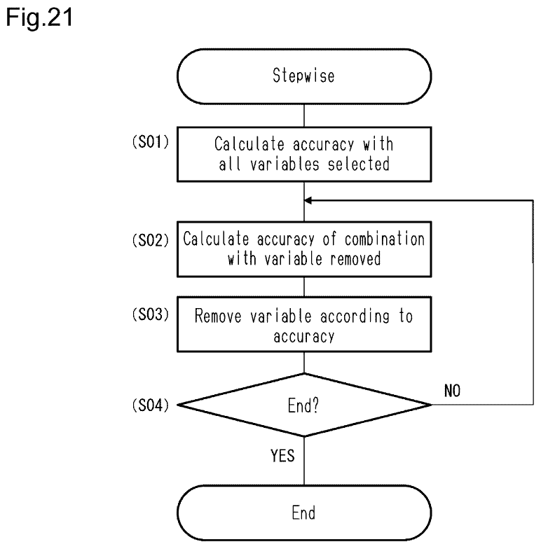

Referring to FIGS. 21 to 24, a backward elimination method is now described that starts with all variables selected in a stepwise method and removes variables one by one.

As shown in FIG. 21, first, accuracy is calculated with all variables selected (step S01). For example, when variables p1 to p4 are used, a regression equation is calculated using all variables (p1 to p4). As the accuracy of this regression equation, a prediction error e0, which is the mean absolute error (MAE), is calculated.

Then, the accuracy of a combination of variables remaining after removing some variables is calculated (step S02).

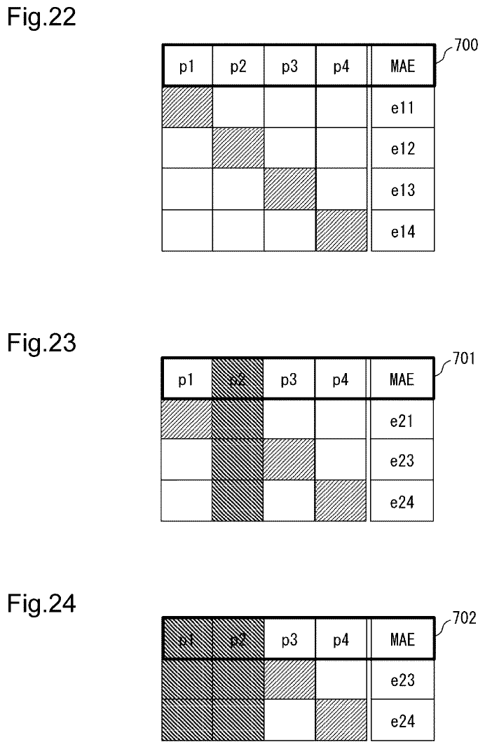

As shown in table 700 of FIG. 22, when variables (p1 to p4) are used, the regression equation is calculated using the combination of variables that remain after removing variables (p1 to p4) one by one. For example, prediction error e11 is calculated as the accuracy of a regression equation that uses the variables (p2 to p4) remaining after removing the variable (p1) from the variables (p1 to p4). Prediction error e12 is calculated as the accuracy of a regression equation that uses the variables (p1, p3, p4) remaining after removing the variable (p2) from the variables (p1 to p4). Prediction error e13 is calculated as the accuracy of a regression equation that uses the variables (p1, p2, p4) remaining after removing the variable (p3) from the variables (p1 to p4). Prediction error e14 is calculated as the accuracy of a regression equation that uses the variables (p1 to p3) remaining after removing the variable (p4) from the variables (p1 to p4).

Then, a variable is removed according to the accuracy (step S03). Here, the variable concerning the variable combination with the highest accuracy (the variables with the smallest mean absolute error) is removed. That is, when the mean absolute error of the variable combination that does not include a specific variable is small, this specific variable is removed. When prediction error e12 is the smallest among prediction errors e11 to e14 in FIG. 22, variable p2 corresponding to prediction error e12 is removed from the variables (p1 to p4), as indicated by the hatching pattern in table 701 of FIG. 23.

Then, it is determined whether to end the process of the backward elimination method (step S04). For example, if there are two variables remaining, it is determined to end the process. If it is determined to end the process (YES at step S04), the combination of variables with the highest accuracy is determined as the final result.

If it is determined not to end the process (NO at step S04), the process from step S02 is repeated.

As shown in FIG. 23, a regression equation is calculated using the combination of variables remaining after removing one of the variables (p1, p3, p4). For example, prediction error e21 is calculated as the accuracy of a regression equation that uses the combination of variables (p3, p4) remaining after removing the variable (p1) from the variables (p1, p3, p4). Prediction error e23 is calculated as the accuracy of a regression equation that uses the combination of variables (p1, p4) remaining after removing the variable (p3) from the variables (p1, p3, p4). Prediction error e24 is calculated as the accuracy of a regression equation that uses the remaining variables (p1, p3) after removing the variable (p4) from the variables (p1, p3, p4). When prediction error e21 is the smallest among prediction errors e21, e23, and e24 in FIG. 23, variable p1 corresponding to prediction error e21 is removed from the variables (p1, p3, p4), as indicated by the hatching pattern in table 702 of FIG. 24.

Then, the combination of variables with the highest accuracy (variables with the largest mean absolute error) (here, variables p3 and p4) is identified as the final result.

However, since the backward elimination method described above considers variables one by one, combinations of multiple variables may not be considered. This tends to result in a local solution. For example, in the examples shown in FIGS. 22 to 24, variable p2 is first removed. Thus, variable combinations including variable p2 are not considered after variable p2 is removed. Also, when there are numerous variables, the number of trials will be significantly large, lengthening the calculation time.

### Variable Selection Process

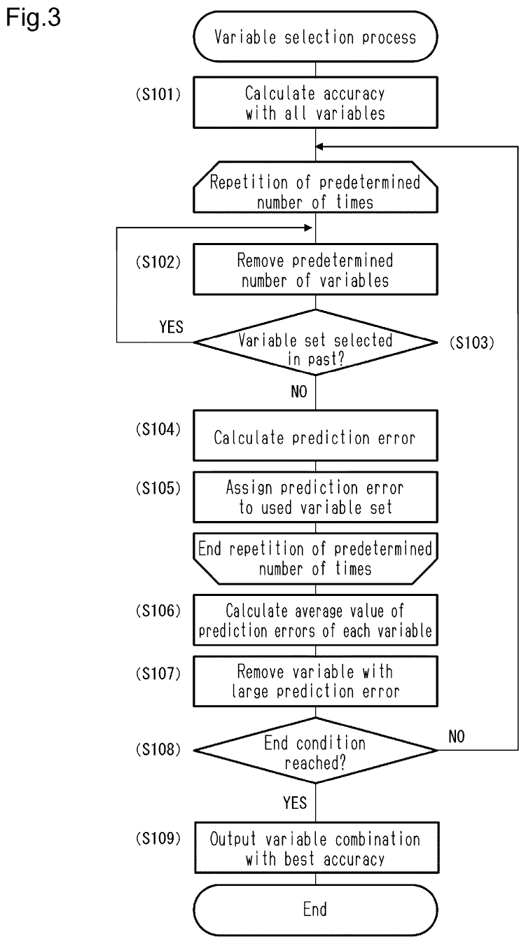

Referring to FIG. 3, a variable selection process of the present embodiment is now described. In this process, the selection unit 211 of the control unit 21 of the support server 20 obtains input data from the user terminal 10. The selection unit 211 records the input data in the storage unit 22.

First, the control unit 21 of the support server 20 performs accuracy calculation processing with all variables (step S101). Specifically, the selection unit 211 of the control unit 21 creates a data set (training data group) including all variable values in the input data recorded in the storage unit 22. The selection unit 211 then provides the created data set to the evaluation unit 212. The evaluation unit 212 creates an analytical model by performing machine learning using the data set. The evaluation unit 212 then calculates the accuracy (prediction error) of the created analytical model.

The control unit 21 of the support server 20 then repeats the following process a predetermined number of times.

The control unit 21 of the support server 20 performs processing of removing a predetermined number of variables (step S102). Specifically, the selection unit 211 of the control unit 21 randomly specifies a predetermined number of different types of variables (used variable set) from the variables included in the input data. In this embodiment, two variables are specified as variables to be removed. The remaining variables that are not removed are the used variables. Here, the used variable set includes six variables.

Then, the control unit 21 of the support server 20 performs processing of determining whether the specified used variable set matches a variable set selected in the past (step S103). Specifically, the selection unit 211 of the control unit 21 compares the current used variable set with the used variable sets that have already been evaluated.

If the current used variable set matches one of the used variable sets that have been evaluated, and it is thus determined that the currently specified used variable set matches a used variable set selected in the past (YES at step S103), processing of removing a predetermined number of variables (step S102) is repeated.

If it is determined that the currently specified used variable set is not a used variable set that is selected in the past (NO at step S103), the control unit 21 of the support server 20 performs processing of calculating a prediction error (Step S104). Specifically, the selection unit 211 of the control unit 21 creates a data set of the current used variable set. The selection unit 211 then provides the created data set to the evaluation unit 212. The evaluation unit 212 creates an analytical model by performing machine learning using the data set. The evaluation unit 212 then calculates the accuracy (prediction error) of the created analytical model.

The control unit 21 of the support server 20 then performs processing of assigning the prediction error to the used variable set (step S105). Specifically, the selection unit 211 of the control unit 21 assigns, as a distribution value, the calculated prediction error to each variable in the used variable set.

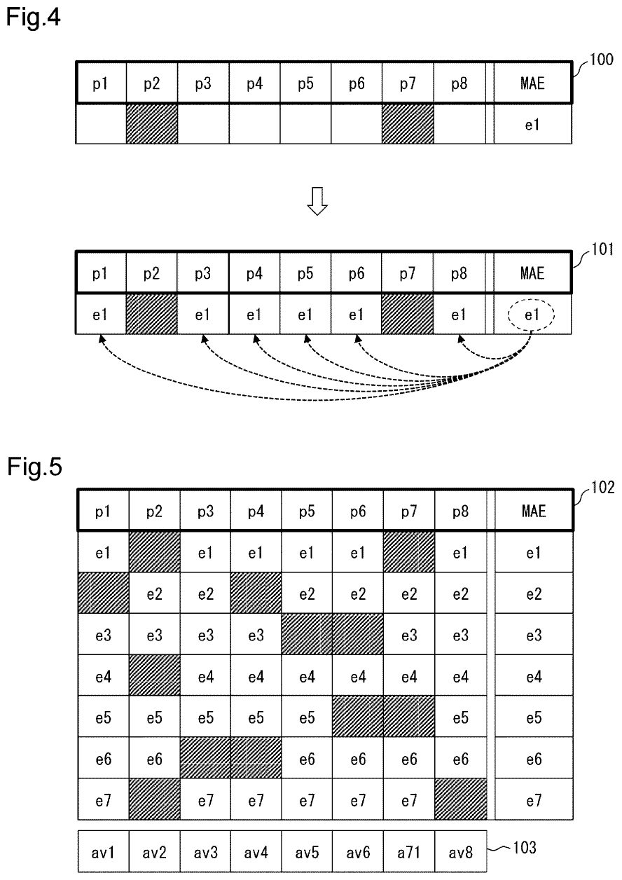

As shown in FIG. 4, an example will now be discussed in which variables (p1 to p8) are used, and variables p2 and p7 are removed. As shown in variable table 100, in the processing of calculating a prediction error (step S104), prediction error e1 is obtained. Then, in the processing of assigning the prediction error to the used variable set (step S105), prediction error e1 is assigned to each of the variables (p1, p3 to p6, and p8) as shown in variable table 101.

The above process is repeated a predetermined number of times.

As shown in FIG. 5, after repeating the process seven times (the predetermined number in this example), variable table 102 is created. Here, prediction errors e1 to e7 are calculated for the used variable sets, and prediction errors e1 to e7 are assigned to the respective used variables.

Then, the control unit 21 of the support server 20 performs processing of calculating the average value of the prediction errors for each variable (step S106). Specifically, the selection unit 211 of the control unit 21 calculates a statistical value, an average value in this example, of the prediction errors assigned to each variable.

In this case, as shown in the average value column 103 of FIG. 5, average values av1 to av8 of the prediction errors (e1 to e7) assigned to the variables (p1 to p8) are calculated. For example, the average value av1 of the prediction errors of variable p1 is the average value of prediction errors e1 and e3 to e7.

The control unit 21 of the support server 20 then performs processing of removing a variable with a large prediction error (step S107). Specifically, the selection unit 211 of the control unit 21 identifies a variable with a large average value of prediction errors. The selection unit 211 then removes the variable with the large prediction error average value. In this case, the selection unit 211 temporarily stores the prediction errors in the memory in association with the remaining variable set.

The control unit 21 of the support server 20 then performs processing of determining whether the end condition has been reached (step S108). Specifically, the selection unit 211 of the control unit 21 checks whether the number of repetitions N is equal to the target number Nmax (end condition). The end condition is not limited to the target number Nmax. The end condition may be a maximum calculation time that is set in advance.

If the number of repetitions N has not reached the target number Nmax, and it is thus determined that the end condition has not been reached (NO at step S108), the control unit 21 of the support server 20 adds 1 to the number of repetitions N. Then, the process from the processing of removing a predetermined number of variables (step S102) is repeated.

If the number of repetitions matches the target number Nmax, and it is thus determined that the end condition has been reached (YES at step S108), the control unit 21 of the support server 20 performs processing of outputting the combination of variables with the highest accuracy (step S109). Specifically, the selection unit 211 of the control unit 21 identifies, among the variable sets temporarily stored in the memory, the variable set with the smallest prediction error. Then, the selection unit 211 outputs the identified variable set to the user terminal 10.

The present embodiment has the following advantageous influences.

(1-1) In the present embodiment, the control unit 21 of the support server 20 performs processing of removing a predetermined number of variables (step S102), processing of calculating a prediction error (step S104), and processing of assigning a prediction error to the used variable sets (step S105). As a result, multiple combinations of variables are considered, while limiting obtainment of local solutions. This allows for efficient and accurate selection of information to be used for information processing.

(1-2) In the present embodiment, the control unit 21 of the support server 20 performs processing of calculating the average value of prediction errors of each variable (step S106) and processing of removing a variable with a large prediction error (step S107). This allows variables with large statistical errors to be removed. In other words, it may be considered that the average prediction error of each variable reflects the effectiveness of the variable. Like Hebb's rule, repeated learning emphasizes effective combinations of variables.

The above embodiment was evaluated by artificially creating 32-dimensional learning data (two-class classification), for example. The prediction error of a support vector machine (SVM) using 32 selection variables was 0.246. When the stepwise method and an SVM were used, the number of selected variables was 11, and the prediction error was 0.141. Furthermore, when the above embodiment and an SVM were used, the number of selected variables was nine, and the prediction error was 0.137. As such, the above embodiment achieved higher accuracies than the stepwise method.

### Second Embodiment

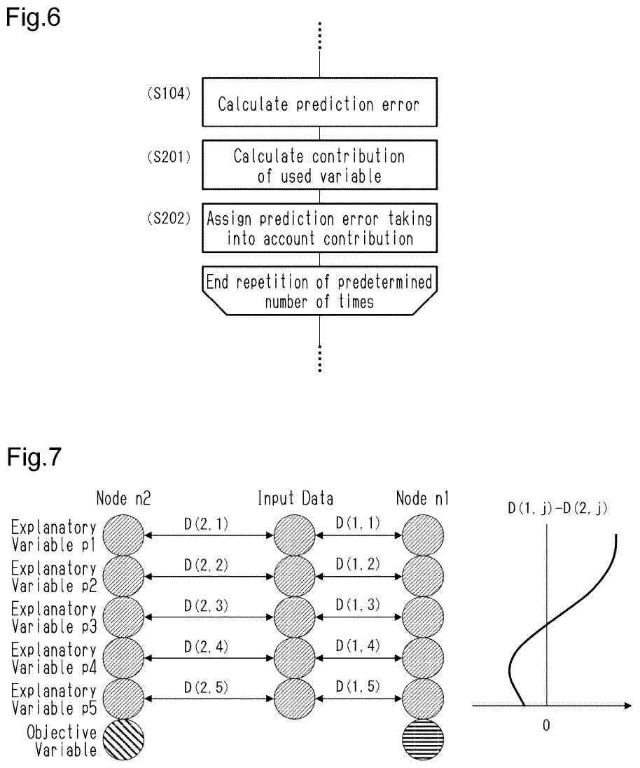

Referring to FIG. 6, an information selection system, an information selection method, and an information selection program according to a second embodiment will now described. In the first embodiment, a method has been described in which a prediction error is simply assigned to each used variable. The second embodiment has a modified configuration in which a prediction error is assigned to each used variable such that the prediction error reflects the effectiveness of the variable. In the following description of the second embodiment, same reference numerals are given to those that are the same as the first embodiment. Detailed descriptions of such configurations are omitted.

As shown in FIG. 6, after processing of calculating a prediction error (step S104), the control unit 21 of the support server 20 performs processing of calculating a contribution of a used variable (step S201). This step calculates a contribution of each used variable to the accuracy (prediction error) calculated using the used variable set.

A self-organizing map (SOM) is used to calculate the contribution (effectiveness) of each variable. Thus, the storage unit 22 of the support server 20 records the created self-organizing map. The self-organizing map is recorded as the learning process is performed. A self-organizing map includes nodes arranged in a multi-dimensional space and paths connecting the nodes. Each of the paths and nodes has information regarding age. The age is incremented by 1 when a new piece of input data is obtained. Each of the paths and nodes also has information regarding its activation value. The activation value is an index representing the effectiveness (significance of existence) of each path and node.

Referring to FIG. 7, the concept of contribution is described using a self-organizing map. In this self-organizing map, each node includes input variables and an objective variable. An example will now be discussed in which the self-organizing map predicts an objective variable for the explanatory variables of five dimensions of a piece of input data. When the explanatory variables of the piece of input data are applied to the self-organizing map, first and second nodes n1 and n2 are determined as winning nodes. In this case, the objective variable value of the closest node is used as the predicted value. The difference D(1, j)−D(2, j) between the distance D(1, j) between the explanatory variables of the first node n1 and the piece of input data and the distance D(2, j) between the explanatory variables of the second node n2 and the piece of input data is calculated. In the expressions, “j” indicates the type of the explanatory variable.

By obtaining the difference D(1, j)−D(2, j), explanatory variables that are closer to the first node n1 and explanatory variables that are closer to the second node n2 are identified. When the explanatory variable values of the second node n2 are preferable to the explanatory variable values of the first node n1 with respect to the objective variable value of the piece of input data, the objective variable of the second node n2 is closer. In other words, explanatory variables with positive differences indicate that they have a positive influence on the prediction. In contrast, explanatory variables with negative differences indicate that they have a negative influence on the prediction. As such, the difference is used as an index representing the contribution of the explanatory variable.

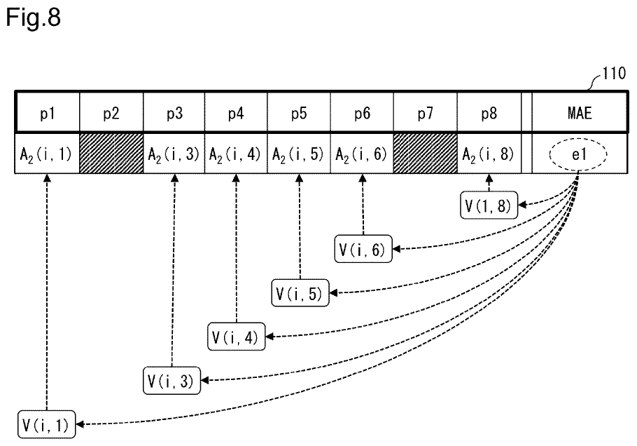

As shown in table 110 of FIG. 8, an example will now be discussed in which variables (p1, p3 to p6, and p8) are selected and prediction error e1 is calculated as the accuracy. In this case, the contribution V(i, j) of each variable (p1, p3 to p6, p8) to the calculated prediction error e1 is calculated.

The contribution V(i, j) is calculated by the following expression.

$$V ( i , j ) = - {\sum }_{k - 1}^{{N}_{d}} {\sum }_{i - 2}^{{N}_{n}} {ddA}_{i , j} ( l ) \frac{{dD}_{i , k} ( i , j )}{{\sum }_{m} \vert {dD}_{i , k} ( l , m ) \vert} \qquad [ Expression 1 ]$$

i: Number-of-trials index of trials for verifying accuracy by randomly selecting variables (1 to Nmax)
j: Variable index
N_{d}: Number of piece of data
Nₙ: Number of pieces of neighboring data considered (usually 2 to 3)
ddA_{i,k}(l)=dA_{i,k}(l)−dA_{i,k}(l): Difference between distances of objective variables of correct answer and nodes
dD_{i,k}(l, j)=D_{i,k}_{²}(l, j)−D_{i,k}_{²}(l, j): Squared difference between distances between input and nodes
dA_{i,l}(k): Objective variable of l-th neighboring node of data number k in i-th trial−objective variable of data number k (correct answer)
D_{i,k}(l, j): Explanatory variable of l-th neighboring node of data number k in i-th trial−explanatory variable of data number k

The control unit 21 of the support server 20 then performs processing of assigning prediction errors taking into account the contributions (step S202).

As shown in FIG. 8, using the contributions of the variables (p1, p3 to p6, and p8) and prediction error e1, distribution values (A₂(i, 1), A₂(i, 3) to A₂(i, 6), and A₂(i, 8)) are assigned to the variables.

The distribution value A₂ to be set for each variable is calculated using the following expression.

$${A}_{2} ( i , j ) = {A}_{1} ( i ) {δ}_{i , j} - V ( i , j ) \frac{{σ}_{2}}{{σ}_{1} ( i )} k \qquad [ Expression 2 ]$$

i: Number-of-trials index of trials for verifying accuracy by randomly selecting variables (1 to Nmax)
j: Variable index
δ_{i,j}=0: Dimension j is not selected in i-th trial.
δ_{i,j}=1: Dimension j is selected in i-th trial.
A₂(i, j): Accuracy with consideration given to effectiveness of variable j in i-th trial
A₁(i): Prediction error (e.g., MAE) obtained in i-th trial
V(i, j): Effectiveness of variable j obtained in i-th trial (0 for variable that is not selected)
σ₁(i): Standard deviation of selected variables of V (i, 1 to N_{d}) obtained in i-th trial
σ₂: Standard deviation of A₁(1 to Nₘₐₓ).
N_{d}: Number of pieces of data
Nₘₐₓ: Number of trials
k: Tuning parameter [0 1]

### Method for Creating Self-Organizing Map

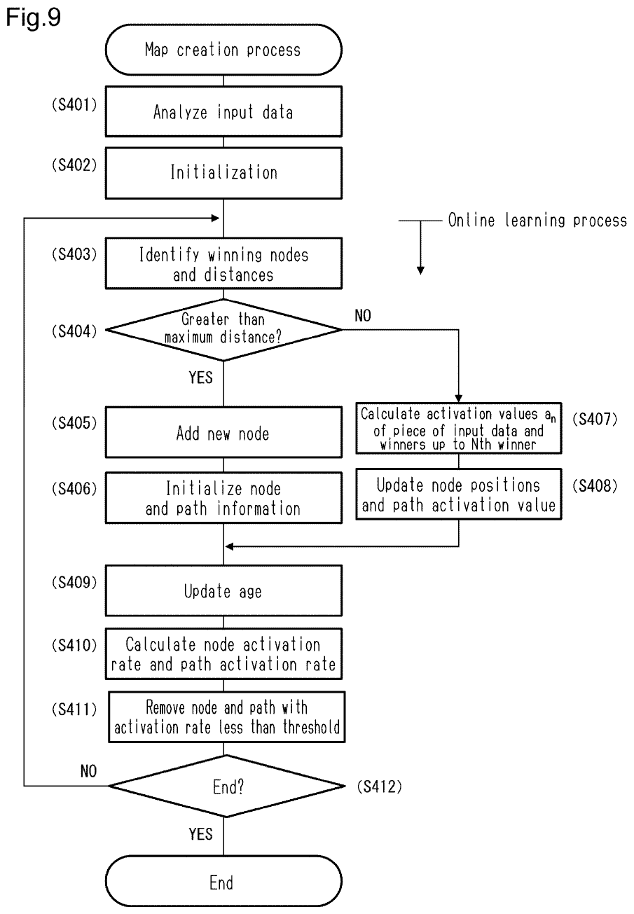

Referring to FIG. 9, a process for creating a self-organizing map used in processing of calculating the contribution of a used variable (step S201 in FIG. 6) is now described. In this process, input data is obtained from the user terminal 10. The selection unit 211 of the control unit 21 of the support server 20 records the input data in the storage unit 22. Here, input data including explanatory variables and objective variables is used. In this case, the control unit 21 of the support server 20 verifies the accuracy of learning while creating a map. Then, when the learning accuracy has not reached the reference value, the control unit 21 of the support server 20 performs cross-verification to search for an optimal value for the tuning coefficient, which is a learning hyperparameter, that causes the learning accuracy to be equal to or higher than the reference value. In this manner, the influence of an objective variable is adjusted by multiplying the variable value of the objective variable by the tuning coefficient.

### Map Creation Process

First, the control unit 21 of the support server 20 performs processing of input data analysis (step S401). Specifically, the evaluation unit 212 of the control unit 21 calculates the maximum distance dmax used to create a node from a piece of input data D(i). With respect to the total number N of pieces of data, the number Nn of pieces of neighboring data of a node and the number Nw of winners to be considered are set in advance.

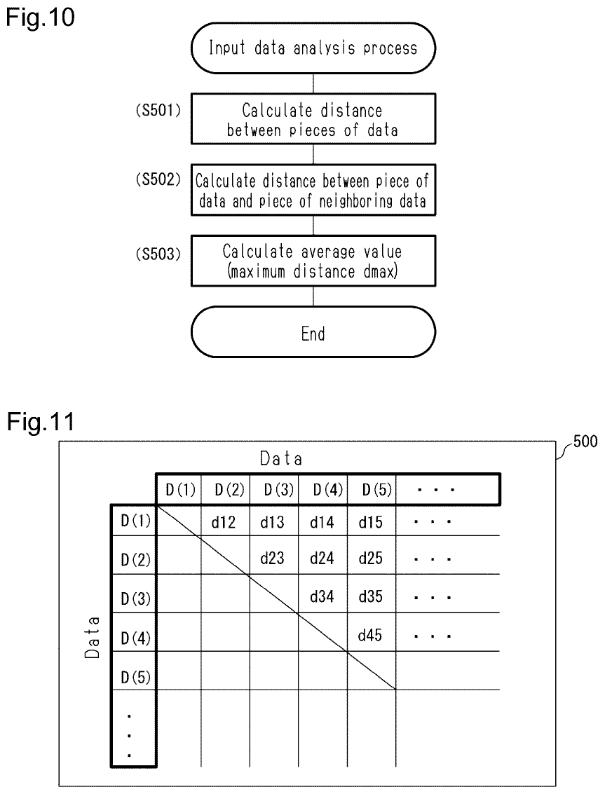

Referring to FIG. 10, the input data analysis (step S401) is described.

First, the control unit 21 of the support server 20 performs a process of calculating the distance between pieces of input data D(i) (step S501). Specifically, the evaluation unit 212 of the control unit 21 calculates the distance between every combination of two pieces of input data D(i).

In this case, as shown in FIG. 11, distance table 500 is created by calculating the distances (d12, d13, . . . , d23, . . . ) between each piece of input data D(i). For example, d12 is the distance between a piece of input data D(1) and a piece of input data D(2). The control unit 21 of the support server 20 then performs processing of calculating the distance between each piece of input data D(i) and a piece of neighboring data (step S502). Specifically, the evaluation unit 212 of the control unit 21 sorts the distances in distance table 500 in ascending order, and obtains the distances up to the Nn-th length.

The control unit 21 of the support server 20 then performs processing of calculating an average value (step S503). Specifically, the evaluation unit 212 of the control unit 21 calculates the average value (statistical value) of the obtained distances up to the Nn-th distance. The average value is recorded in the storage unit 22 as the maximum distance dmax between nodes.

As shown in FIG. 9, the control unit 21 of the support server 20 then performs an initialization process (step S402). Here, the evaluation unit 212 of the control unit 21 determines parameters and initial nodes.

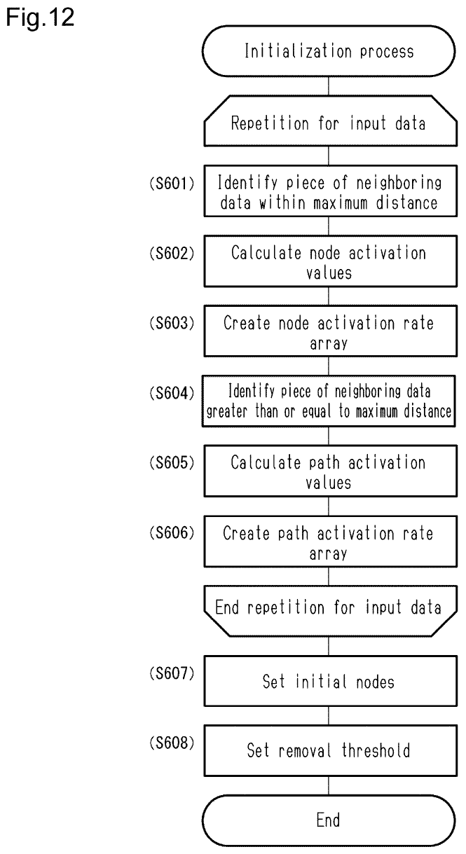

Referring to FIG. 12, the initialization process (step S402) is described. In this step, all pieces of input data D(i) are treated as nodes.

First, the control unit 21 of the support server 20 repeats the following process while sequentially specifying each piece of input data D(i) as a processing target from i=1.

The control unit 21 of the support server 20 performs processing of identifying a piece of neighboring data within the maximum distance (step S601). Specifically, the evaluation unit 212 of the control unit 21 identifies all pieces of neighboring data having a distance from the piece of input data D(i) to be processed that is within the maximum distance dmax.

The control unit 21 of the support server 20 then performs processing of node activation value calculation (step S602). Specifically, the evaluation unit 212 of the control unit 21 calculates the node activation value Aw(ni) of each piece of neighboring data by the following expression.

$${A}_{w} ( {n}_{i} ) = exp ( - \frac{{d}^{2}}{d {max}^{2}} ) \qquad [ Expression 3 ]$$

The control unit 21 of the support server 20 then performs processing of creating a node activation rate array (step S603). Specifically, the evaluation unit 212 of the control unit 21 creates [Arate_W(i) i=1 to N] in which the activation values of all nodes are arranged in a one-dimensional array. This [Arate_W(i) i=1 to N] is a one-dimensional array, and [Arate_W(i) i=1 to N] contains the activation values of all nodes. The evaluation unit 212 then calculates a node activation rate Arate_W(i). This node activation rate Arate_W(i) is calculated by dividing the sum of the node activation values of the pieces of data within the maximum distance dmax from the node ni by the age.

The control unit 21 of the support server 20 then performs processing of identifying a piece of neighboring data having a distance greater than or equal to the maximum distance (step S604). Specifically, the evaluation unit 212 of the control unit 21 identifies another piece of input data D(j) having a distance from the piece of input data D(i) to be processed that is greater than or equal to the maximum distance dmax.

The control unit 21 of the support server 20 then performs processing of path activation value calculation (step S605). Specifically, the evaluation unit 212 of the control unit 21 calculates the path activation value As(n1, n2) of each piece of neighboring data (piece of input data D(j)) by the following expression. Assuming that nodes at opposite ends of the path are a first node n1 and a second node n2, d1 is the distance between the first node n1 and the piece of data D(j), and d2 is the distance between the second node n2 and the piece of data D(j).

$${A}_{s} ( {n}_{1} , {n}_{2} ) = exp ( - \frac{{d}_{1}^{2} + {d}_{2}^{2}}{d {max}^{2}} ) \qquad [ Expression 4 ]$$

The control unit 21 of the support server 20 then performs processing of path activation rate array creation (step S606). Specifically, the evaluation unit 212 of the control unit 21 creates [Arate_S(i, j) i=1 to N, j=1 to N] in which the activation values of all paths are arranged in a two-dimensional array. This [Arate_S(i, j) i=1 to N, j=1 to N] is a two-dimensional array, and [Arate_S(i, j) i=1 to N, j=1 to N] includes the activation values of all paths. The evaluation unit 212 then calculates a path activation rate Arate_S(i, j). This path activation rate Arate_S(i, j) is obtained by dividing the sum of node activation values of pieces of data belonging to the path (i, j) by the age.

The above process is repeated for all pieces of input data.

The control unit 21 of the support server 20 then performs an initial node setting process (step S607).

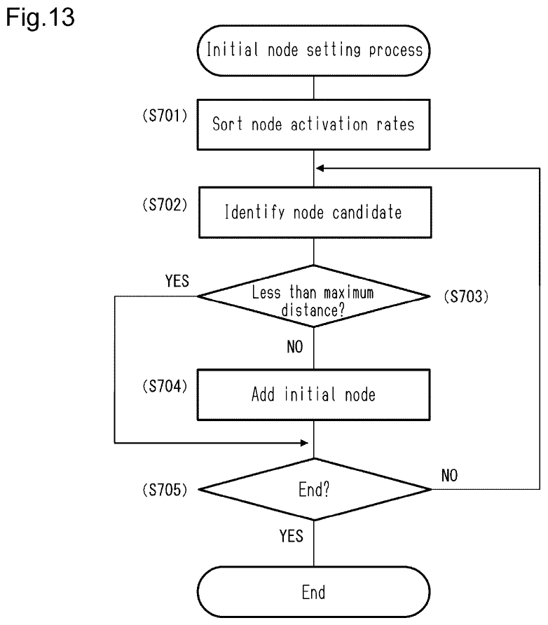

Referring to FIG. 13, the initial node setting process (step S607) is described.

First, the control unit 21 of the support server 20 performs processing of node activation rate sorting (step S701). Specifically, the evaluation unit 212 of the control unit 21 sorts the pieces of input data D(i) in descending order of the node activation rates Arate_W(i).

The control unit 21 of the support server 20 then performs processing of identifying a node candidate (step S702). Specifically, the evaluation unit 212 of the control unit 21 sequentially identifies a piece of input data D(i) with a high activation rate as a node candidate.

The control unit 21 of the support server 20 then performs processing of determining whether the distance is less than the maximum distance (step S703). Specifically, the evaluation unit 212 of the control unit 21 calculates the distance between the node candidate and the already registered node, and compares the calculated distance with the maximum distance dmax.

If it is determined that the distance between the node candidate and the already registered node is greater than or equal to the maximum distance (NO at step S702), the control unit 21 of the support server 20 performs processing of initial node addition (step S704). Specifically, the evaluation unit 212 of the control unit 21 adds the node candidate as a new node and records it in the storage unit 22.

If it is determined that the distance between the node candidate and the already registered node is less than the maximum distance (YES at step S703), the control unit 21 of the support server 20 skips processing of initial node addition (step S704).

The control unit 21 of the support server 20 then performs processing of determining whether to end the process (step S705). Specifically, the evaluation unit 212 of the control unit 21 determines to end the process when processing has been completed for the piece of input data D(i) with the lowest activation rate.

If it is determined not to end the process (NO at step S705), the control unit 21 of the support server 20 repeats the process from the processing of identifying a node candidate (step S702).

If it is determined to end the process (YES at step S705), the control unit 21 of the support server 20 ends the initial node setting process (step S607).

Then, as shown in FIG. 12, the control unit 21 of the support server 20 performs a removal threshold setting process (step S608).

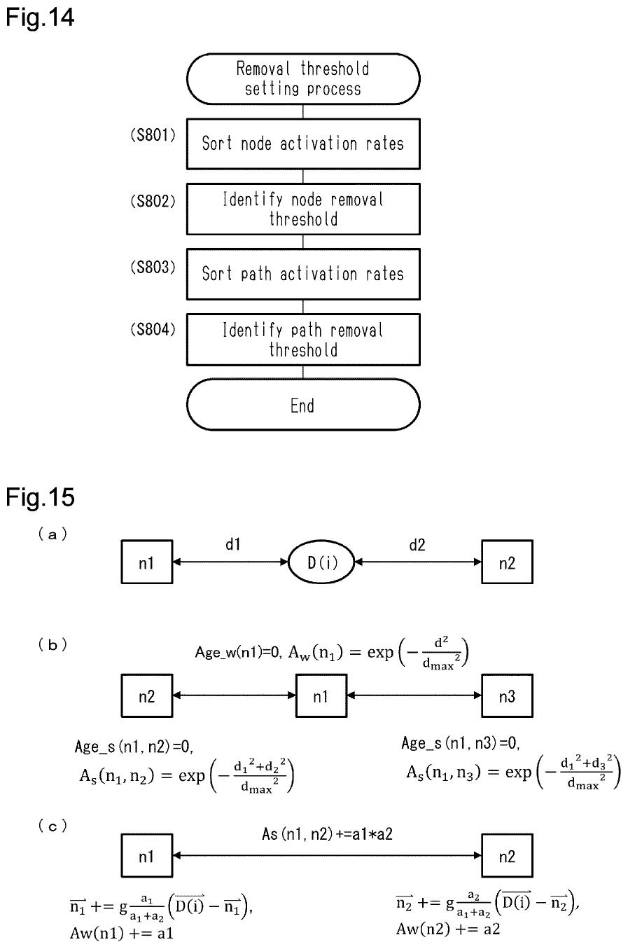

Referring to FIG. 14, the removal threshold setting process (step S608) is now described.

The control unit 21 of the support server 20 performs processing of node activation rate sorting (step S801). Specifically, the evaluation unit 212 of the control unit 21 sorts the node activation rates Arate_W(i) in descending order.

The control unit 21 of the support server 20 then performs processing of identifying a node removal threshold (step S802). Specifically, the evaluation unit 212 of the control unit 21 identifies the value of the node activation rate Arate_W(i) of a specified rank (Ndw) as the node removal threshold, and records it in the storage unit 22.

The control unit 21 of the support server 20 then performs processing of sorting path activation rates (step S803). Specifically, the evaluation unit 212 of the control unit 21 sorts the path activation rates Arate_S(i, j) in descending order.

The control unit 21 of the support server 20 then performs processing of identifying a path removal threshold (step S804). Specifically, the evaluation unit 212 of the control unit 21 identifies the path activation rate Arate_S(i, j) of a specified rank (Nds) as the path removal threshold, and records it in the storage unit 22.

As shown in FIG. 9, an online learning process is then performed. This process is performed when a new piece of input data D(i) is obtained online. Here, it is assumed that i=1 to M.

First, the control unit 21 of the support server 20 performs processing of identifying winning nodes and distances (step S403). Specifically, the evaluation unit 212 of the control unit 21 identifies N nodes (first winner to Nth winner) as neighboring nodes among the nodes (existing nodes) forming the self-organizing map recorded in the storage unit 22. Here, the evaluation unit 212 identifies N nodes (first winner to Nth winner) in order of positional proximity to the newly obtained piece of input data D(i). Then, the evaluation unit 212 calculates the distance (d1 to dn) between the piece of input data D(i) and each winner (first winner to Nth winner).

In part (a) of FIG. 15, two winners (first winner n1 and second winner n2) are identified, and the distance d1, d2 to each winner (n1, n2) from the piece of input data D(i) is calculated.

The control unit 21 of the support server 20 then performs processing of determining whether the calculated distance is greater than the maximum distance (step S404). Specifically, the evaluation unit 212 of the control unit 21 compares the distance d1 between the newly obtained piece of input data D(i) and the closest node (n1) with the maximum distance dmax.

If the distance d1 is greater than the maximum distance (YES at step S404), the control unit 21 of the support server 20 performs processing of adding a new node (step S405). Specifically, the evaluation unit 212 of the control unit 21 records the piece of input data D(i) in the storage unit 22 as a new node.

In part (b) of FIG. 15, the first and second nodes n1 and n2 become the second and third nodes n2 and n3, respectively, and the piece of input data D(i) is added as the first node n1.

The control unit 21 of the support server 20 then performs processing of node and path information initialization (step S406). Specifically, the evaluation unit 212 of the control unit 21 initializes the ages (Age_w, Age_s) and the activation values (Aw, As).

As shown in part (b) of FIG. 15, the information of each node is initialized using the following expression. Here, the first node n1 is initialized.

$$Age\_w ( n 1 ) = 0 \qquad [ Expression 5 ]$$

$${A}_{w} ( {n}_{1} ) = exp ( - \frac{{d}^{2}}{{d}_{max}^{2}} ) \qquad [ Expression 6 ]$$

In the expressions, d is the distance between each node ni and the first node n1.

Also, the path information of the first and second nodes n1 and n2 is updated.

$$Age\_s ( n 1 , n 2 ) = 0 \qquad [ Expression 7 ]$$

$${A}_{s} ( {n}_{1} , {n}_{2} ) = exp ( - \frac{{d}_{1}^{2} + {d}_{2}^{2}}{{d}_{max}^{2}} ) \qquad [ Expression 8 ]$$

The path information of the first and third nodes n1 and n3 is also updated.

$$Age\_s ( n 1 , n 3 ) = 0 \qquad [ Expression 9 ]$$

$${A}_{s} ( {n}_{1} , {n}_{3} ) = exp ( - \frac{{d}_{1}^{2} + {d}_{3}^{2}}{{d}_{max}^{2}} ) \qquad [ Expression 10 ]$$

If the distance d1 is less than or equal to the maximum distance dmax (NO at step S404), the control unit 21 of the support server 20 performs processing of calculating the activation values an of the piece of input data and the winners up to the Nth winner (step S407). Here, the activation values an (n=1 to N) of the new node and the existing winners up to the Nth winner are determined. Specifically, the evaluation unit 212 of the control unit 21 calculates the activation value using the following expression.

$${a}_{n} = exp ( - \frac{{d}^{2}}{{d}_{max}^{2}} ) \qquad [ Expression 11 ]$$

In the expression, d is the distance between each node ni and the piece of input data D(i).

The control unit 21 of the support server 20 then performs processing of updating the node positions and path activation values (step S408).

Specifically, as shown in part (c) of FIG. 15, the evaluation unit 212 of the control unit 21 updates the node position using the following expression.

$${\vec{n}}_{1} += g \frac{{a}_{1}}{{a}_{1} + {a}_{2}} ( \vec{D ( 1 )} - {\vec{n}}_{1} ) \qquad [ Expression 12 ]$$

$${\vec{n}}_{2} += g \frac{{a}_{2}}{{a}_{1} + {a}_{2}} ( \vec{D ( 1 )} - {\vec{n}}_{2} )$$

In the expression, g is a coefficient representing the learning rate.

Furthermore, the evaluation unit 212 updates the path activation value As by the following expression.

$${A}_{s} ( {n}_{1} , {n}_{2} ) = exp ( - \frac{{d}_{1}^{2} + {d}_{2}^{2}}{{d}_{max}^{2}} ) \qquad [ Expression 13 ]$$

$${A}_{s} ( {n}_{1} , {n}_{3} ) = exp ( - \frac{{d}_{1}^{2} + {d}_{3}^{2}}{{d}_{max}^{2}} )$$

The evaluation unit 212 of the control unit 21 also updates the node activation value Aw using the following expression.

$$Aw ( n 1 ) += a 1 \qquad [ Expression 14 ]$$

$$Aw ( n 2 ) += a 2$$

The evaluation unit 212 of the control unit 21 also updates the path activation value As using the following expression.

$$As ( n 1 , n 2 ) += a 1 \times a 2 \qquad [ Expression 15 ]$$

The control unit 21 of the support server 20 then performs processing of age update (step S409). Specifically, the evaluation unit 212 of the control unit 21 updates the ages Age_w and Age_s of the nodes and the paths by adding 1 to the ages.

The control unit 21 of the support server 20 then performs processing of calculating node activation rates and path activation rates (step S410). Specifically, the evaluation unit 212 of the control unit 21 calculates the node activation rate Arate_w by the following expression.

$$Arate\_w = \frac{Aw}{Age w} \qquad [ Expression 16 ]$$

The evaluation unit 212 of the control unit 21 calculates the path activation rate Arate_s by the following expression

$$Arate\_s = \frac{As}{Age \_ s} \qquad [ Expression 17 ]$$

The control unit 21 of the support server 20 then performs processing of removing paths and nodes having activation rates that are below the threshold (step S411). Specifically, the evaluation unit 212 of the control unit 21 removes nodes and paths having activation rates that are below the threshold.

The control unit 21 of the support server 20 then performs processing of determining whether to end the process (step S412). Specifically, if i=M, the evaluation unit 212 of the control unit 21 determines that all pieces of input data have been processed.

In this case, the online learning process ends.

If it is determined not to end the process (NO at step S412), the control unit 21 of the support server 20 sets i=i+1 and repeats the process from step S403.

The present embodiment has the following advantages in addition to advantages (1-1) and (1-2) described above.

(2-1) In the present embodiment, the control unit 21 of the support server 20 performs processing of calculating the contribution of a used variable (step S201) and processing of assigning a prediction error taking into account the contribution (step S202). Since variables have different degrees of influence on the prediction error resulting from the set of variables, the variables can be weighted using the contribution of each node of the self-organizing map. This weighting allows a prediction error to be assigned to each variable.

(2-2) In this embodiment, the control unit 21 of the support server 20 performs processing of input data analysis (step S401). Thus, a self-organizing map is created using pieces of input data including objective variables and explanatory variables. The prediction can be made by calculating distances using the self-organizing map, increasing the interpretability of the prediction result.

(2-3) In this embodiment, the control unit 21 of the support server 20 adjusts explanatory variables and objective variables when creating a self-organizing map. This allows a self-organizing map to be created with the explanatory variables and objective variables balanced.

### Third Embodiment

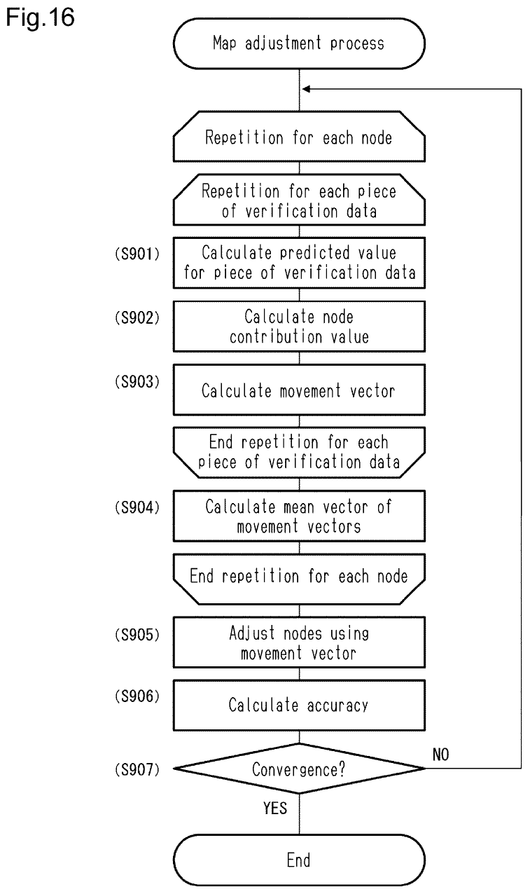

Referring to FIG. 16, an information selection system, an information selection method, and an information selection program according to a third embodiment will now be described. In the second embodiment, supervised learning has been described. The third embodiment has a configuration that is modified to adjust node positions using pieces of verification data. In the following description of the third embodiment, same reference numerals are given to those that are the same as the second embodiment. Detailed descriptions of such configurations are omitted. The third embodiment creates a self-organizing map by coupling explanatory variables and objective variables during learning.

For example, an example will now be discussed in which the first node n1 is predicted as a prediction result obtained using explanatory variable values of pieces of verification data. In this example, the objective variable value of the second node n2 is closer to the objective variable value (correct answer) of the piece of verification data than the objective variable value of the first node n1. In this case, by comparing the distances d (node contribution values) of the explanatory variables in each dimension, the dimension that has a negative influence can be identified.

Referring to FIG. 16, a map adjustment process is now described.

The following process is repeated for each node and each piece of verification data.

First, the control unit 21 of the support server 20 performs processing of calculating a predicted value of a piece of verification data (step S901). Specifically, the evaluation unit 212 of the control unit 21 inputs the explanatory variable values of the pieces of verification data into a self-organizing map and thus identifies the node that is closest (closest node). Then, the evaluation unit 212 obtains the objective variable value of the closest node as a predicted value.

The control unit 21 of the support server 20 then performs processing of node contribution value calculation (step S902). Specifically, the evaluation unit 212 of the control unit 21 calculates a node contribution value dAi,j using the following difference.

$${dA}_{i , j} = \vert {dA}_{predict}^{j} - {dA}_{true}^{j} \vert - \vert {dA}_{predict wo i}^{j} - {dA}_{true}^{j} \vert \qquad [ Expression 18 ]$$

i: Node number
j: Data number concerning node i
   A_{predict}^{j}: Predicted value of piece of data j
   Aₜᵣᵤₑ^{j}: Correct answer of piece of data j
   A_{predict wo 1}^{j}: Predicted value of piece of data j with node i removed

The control unit 21 of the support server 20 then performs movement vector calculation processing (step S903). Specifically, the evaluation unit 212 of the control unit 21 calculates a movement vector dVi,j using the following expression.

$$\vec{{dV}_{i , j}} = - {dA}_{i , j} ( \vec{{d}_{j}} - \vec{{n}_{i}} ) \qquad [ Expression 19 ]$$

The above process is repeated until all pieces of verification data are processed.

The control unit 21 of the support server 20 then performs processing of calculating the mean vector of the movement vectors (step S904). Specifically, the evaluation unit 212 of the control unit 21 obtains a movement vector (mean vector) dVi,mean by the following expression.

$${dV}_{i , mean} = {\sum }_{j} {dV}_{i , j} \qquad [ Expression 20 ]$$

The above process is repeated until all nodes are processed.

The control unit 21 of the support server 20 then performs processing of adjusting nodes using the movement vector (step S905). Specifically, the evaluation unit 212 of the control unit 21 moves nodes using the movement vector dVi,mean multiplied by the tuning coefficient.

The control unit 21 of the support server 20 then performs processing of accuracy calculation (step S906). Specifically, the evaluation unit 212 of the control unit 21 predicts the objective variable value by inputting the explanatory variables of the piece of verification data into the adjusted self-organizing map. The evaluation unit 212 then calculates the proportion of correct prediction (accuracy) by comparing the predicted objective variable value and the objective variable of each piece of the verification data.

The control unit 21 of the support server 20 then performs processing of determining whether convergence has been achieved (step S907). Specifically, a prediction unit 213 of the control unit 21 compares the accuracy of the previously created map with the accuracy of the currently created map. Then, if the accuracy has been improved, that is, if the accuracy of the currently created map is higher than the accuracy of the previously created map, it is determined that convergence has not been achieved. The convergence determination is not limited to determining whether accuracy has improved. For example, convergence may be determined when the accuracy improvement is within a predetermined range.

If it is determined that the accuracy has been improved, that is, convergence has not been achieved (NO at step S907), the control unit 21 of the support server 20 sets the accuracy of the currently created map as the initial accuracy, and repeats the process from step S901.

If it is determined that the accuracy has not been improved, that is, convergence is achieved (YES at step S907), the control unit 21 of the support server 20 ends the map adjustment process.

The present embodiment has the following advantages in addition to advantages (1-1) and (1-2) and (2-1) to (2-3) described above.

(3-1) The control unit 21 of the support server 20 performs processing of node contribution value calculation (step S902). This enables analysis of the cause of prediction failure based on the node contribution values. In other words, based on the magnitude relationship between the distance between each piece of the verification data and the correct node and the distance between each piece of the verification data and the incorrect node in each dimension, a node that has a positive influence on the prediction and a node that has a negative influence on the prediction can be identified.

(3-2) In the present embodiment, the control unit 21 of the support server 20 performs movement vector calculation processing (step S903). This allows the node that has caused the prediction failure to be moved, thereby improving the self-organizing map.

The present embodiment may be modified and implemented as follows. The embodiment and the following modifications may be combined to an extent that does not cause technical contradiction.

In the first embodiment, the control unit 21 of the support server 20 performs processing of removing a predetermined number of variables (step S102). Although two variables are specified as removal targets, the number of variables to be removed is not limited to two, as long as multiple types of variables are specified as removal targets.

In the first embodiment, the control unit 21 of the support server 20 performs processing of removing a predetermined number of variables (step S102) and processing of calculating a prediction error (step S104). In this embodiment, the predetermined number of variables among different explanatory variables is removed, and an analytical model is created using training data including some remaining variables that are not removed. As long as multiple analytical models can be created by sequentially using a subset of information including multiple pieces of training data, the target of removal does not need to be variables. For example, an analytical model may be created using a data set (a subset of multiple pieces of training data) created by removing a predetermined number of pieces of training data.

In the first embodiment described above, machine learning is performed as the information processing, but the information processing is not limited to machine learning. Any information processing may be performed that creates an analytical model.

In the first embodiment described above, online learning processing is performed. However, it is not limited to online processing and any processing may be performed that creates a self-organizing map. For example, clustering may be performed using a self-organizing map created by batch processing.

In the first embodiment, the control unit 21 of the support server 20 calculates the maximum distance dmax in processing of analyzing input data (step S401). The maximum distance dmax may be any statistical value representing a piece of input data. There is no limitation on the method for calculating the maximum distance dmax. Alternatively, the initial value of the maximum distance dmax may be set in advance, and the maximum distance dmax may be recalculated as the number of pieces of input data increases.

In the second embodiment, the control unit 21 of the support server 20 uses a self-organizing map (step S201 in FIG. 6). Specifically, the evaluation unit 212 of the control unit 21 identifies the node that is closest to the variable values of the explanatory variables of the pieces of input data. The objective variable may be predicted by regression using multiple nodes connected to the closest first node n1.

In this case, multiple nodes may be identified using other nodes that are connected to the closest first node n1 by paths.

In the third embodiment, a node position is adjusted using the node contribution value (step S902 in FIG. 16). Alternatively or additionally, a node position may be adjusted based on the contribution value of the path. For example, an example will now be discussed in which the objective variable value of the second node n2 is closer to the objective variable value (correct answer) of each piece of verification data than the objective variable value of the first node n1 predicted using the explanatory variable values of the pieces of verification data. In this case, by comparing the distances D of the explanatory variables in each dimension, the dimension that has a negative influence is identified.

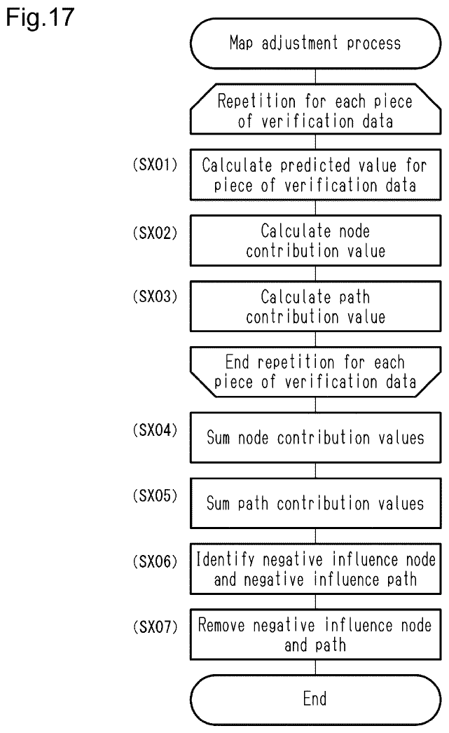

Referring to FIG. 17, a map adjustment process is now described.

The following process is repeated for each piece of verification data.

First, the control unit 21 of the support server 20 performs predicted value calculation processing on pieces of verification data, in the same manner as step S901 (step SX01).

The control unit 21 of the support server 20 then performs processing of node contribution value calculation (step SX02), in the same manner as step S902.

The control unit 21 of the support server 20 then performs processing of path contribution value calculation (step SX03). Specifically, the evaluation unit 212 of the control unit 21 calculates the path contribution value dAk,l (l is a lowercase L) using the following difference.

$${dA}_{k , l} = \vert {dA}_{predict}^{j} - {dA}_{true}^{j} \vert - \vert {dA}_{predict wo k}^{j} - {dA}_{true}^{j} \vert \qquad [ Expression 21 ]$$

k: Node number
L: Data number concerning node k
   A_{predict}^{l}: Predicted value of piece of data l
   Aₜᵣᵤₑ^{l}: Correct answer of piece of data l
   A_{predict wo k}^{l}: Predicted value of piece of data l with node k removed

The above process is repeated until all pieces of verification data are processed.

The control unit 21 of the support server 20 then performs processing of summing the contribution values of the nodes (step SX04). Specifically, the evaluation unit 212 of the control unit 21 calculates the total contribution value dASi of the nodes using by following expression.

$${dAS}_{i} = {\sum }_{j} {dA}_{i , j} \qquad [ Expression 22 ]$$

The control unit 21 of the support server 20 then performs processing of summing the path contribution values (step SX05). Specifically, the evaluation unit 212 of the control unit 21 calculates the total path contribution value dASk by the following expression.

$${dAS}_{k} = {\sum }_{l} {dA}_{k , l} \qquad [ Expression 23 ]$$

The control unit 21 of the support server 20 then performs processing of identifying nodes having a negative influence and paths having a negative influence (step SX06). Specifically, the evaluation unit 212 of the control unit 21 sorts the total node contribution values dASi and the total path contribution values dASk separately in descending order. Then, the evaluation unit 212 identifies the nodes and paths corresponding to the predetermined numbers of dASi and dASk from the top as negative influence nodes and negative influence paths.

The control unit 21 of the support server 20 then performs processing of removing negative influence nodes and negative influence paths (step SX07). Specifically, the evaluation unit 212 of the control unit 21 removes the identified negative influence nodes and negative influence paths.

When a total node contribution value dASi is positive, or a total path contribution value dASk is positive, the corresponding node or path is likely to have a negative influence on the prediction. In this respect, this map adjustment process uses node contribution values and path contribution values to remove nodes or paths having negative influences.

The second embodiment uses a self-organizing map in which each path and node has information regarding age. An evolving self-organizing map (ESOM: Evolving SOM) may also be used as a learning technique that increments neurons as needed during learning. Furthermore, a self-organizing incremental neural network (SOINN) may also be used. SOINN is an online unsupervised learning technique achieved by extending growing neural gas (GNG) and a self-organizing map (SOM) and supports incremental learning. Specifically, SOINN forms a network in a self-organizing manner for input data that is obtained online from distributions having non-stationary, complex shapes that dynamically change, and outputs phase structures of the appropriate number of classes and input data distribution.

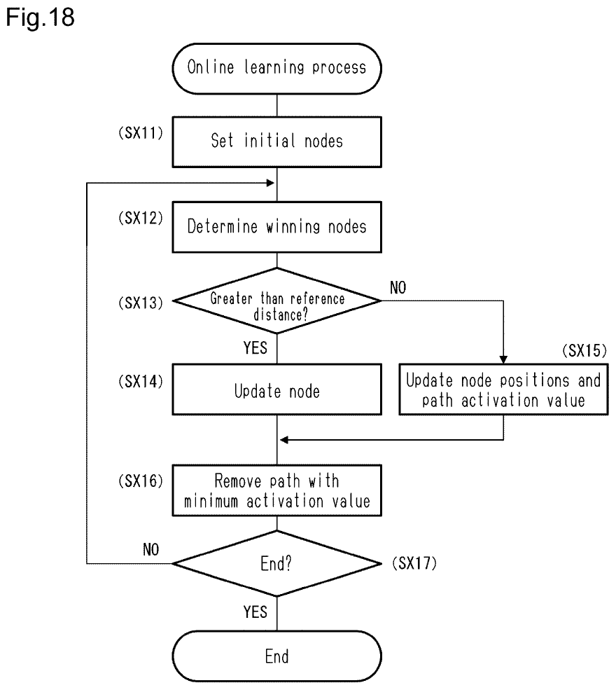

Referring to FIG. 18, an online learning process of an ESOM is now described.

First, the control unit 21 of the support server 20 sets initial nodes (step SX11). Specifically, the control unit 21 of the support server 20 randomly selects two pieces of input data D(i) (i=1 to M) and sets them as initial nodes. In this case, data index i=1.

The control unit 21 of the support server 20 then determines winning nodes (step SX12).

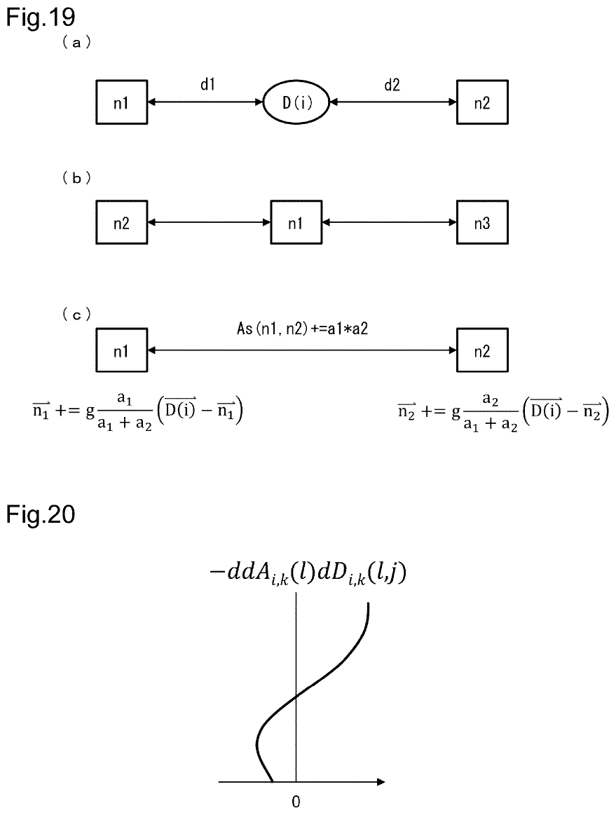

As shown in part (a) of FIG. 19, this step obtains the first node n1 (first winner, distance d1 from the piece of input data D(i)) that is closest to the piece of input data D(i) and the second node n2 (second winner, distance d2 from the piece of input data D(i)) that is second closest.

The control unit 21 of the support server 20 then determines whether the distance d1 from the piece of input data D(i) to the first winner (n1) is longer than a reference distance (step SX13).

If the distance d1 is longer than the reference distance (YES at step SX13), the control unit 21 of the support server 20 updates the piece of input data D(i) to a node (step SX14). Then, based on the winning node, n1 is updated to n2, D(i) is updated to n1, and n2 is updated to n3. Also, the path activation value is initialized (As(n1, :)=0).

As shown in part (b) of FIG. 19, a new first node n1 is created.

If the distance d1 is less than or equal to the reference distance (NO at step SX13), the control unit 21 of the support server 20 updates the node positions and the path activation value (step SX15).

Specifically, as shown in part (c) of FIG. 19, activation values a1 and a2 are determined according to the distances between the piece of input data D(i) and each of the first and second nodes n1 and n2.

$$\vec{{n}_{1}} += g \frac{{a}_{1}}{{a}_{1} + {a}_{2}} ( \vec{D ( i )} - \vec{{n}_{1}} ) \qquad [ Expression 24 ]$$

$$\vec{{n}_{2}} += g \frac{{a}_{2}}{{a}_{1} + {a}_{2}} ( \vec{D ( i )} - \vec{{n}_{2}} )$$

Also, the node positions and the path activation value As(n1, n2) are updated as shown below (Hebb's rule).

$$As ( n 1 , n 2 ) += a 1 \times a 2 \qquad [ Expression 25 ]$$

If mod(i, designated interval)=0, the path with the lowest activation value is removed (step SX16).

The control unit 21 of the support server 20 then determines whether to end the process (step SX17). If i=M (YES at step SX17), the control unit 21 of the support server 20 ends the online learning process. If i≠M (NO at step SX17), the control unit 21 of the support server 20 sets i=i+1 and repeats the process from step SX12.

In the second embodiment, the control unit 21 of the support server 20 performs processing of calculating the contribution of a used variable (step S201) and processing of assigning a prediction error taking into account the contribution (step S202). To ensure that the positive and negative contribution values of dD_{i,k}(l, j) are equally represented, the processing may be separated based on the sign of dD_{i,k}(l, j). For example, when there are fewer instances where dD_{i,k}(l, j) is positive and more instances where it is negative, calculating without separating the processing based on the sign of dD_{i,k}(l, j) may underestimate the contribution values of positive data. By separating the processing based on the sign of dD_{i,k}(l, j), the contribution values are calculated equally.

As such, when dD_{i,k}(i, j)>0, the following expression is used to calculate the sum of the variables for which the first node n1 is farther from the correct answer than the second node n2.

$$V ( i , j ) = - {\sum }_{k = 1}^{{N}_{d}} {\sum }_{l = 2}^{{N}_{n}} {ddA}_{i , k} ( l ) \frac{{dD}_{i , k} ( l , j )}{{\sum }_{m = {[ {dD}_{i , k} ( l , m ) > 0 ]}^{\vert {dD}_{i , k} ( i , m ) \vert}}} \qquad [ Expression 26 ]$$

When dD_{i,k}(i, j)<0 the following expression is used to calculate the sum of the variables for which the first node n1 is farther from the correct answer than the second node n2.

$$V ( i , j ) = - {\sum }_{k = 1}^{{N}_{d}} {\sum }_{l = 2}^{{N}_{n}} {ddA}_{i , k} ( l ) \frac{{dD}_{i , k} ( l , j )}{{\sum }_{m = {[ {dD}_{i , k} ( l , m ) < 0 ]}^{\vert {dD}_{i , k} ( i , m ) \vert}}} \qquad [ Expression 27 ]$$

i: Number-of-trials index of trials for verifying accuracy by randomly selecting variables (1 to Nmax)
j: Variable index
N_{d}: Number of piece of data
Nₙ: Number of piece of neighboring data considered (usually 2 to 3)
ddA_{i,k}(l)=dA_{i,k}(l)−dA_{i,k}(l): Difference between distances of objective variables of correct answer and nodes
dD_{i,k}(l, j)=D_{i,k}_{²}(l, j)−D_{i,k}_{²}(l, j): Squared difference between distances between input and nodes
dA_{i,l}(k): Objective variable of l-th neighboring node of data number k in i-th trial−objective variable of data number k (correct answer)
D_{i,k}(l, j): Explanatory variable of l-th neighboring node of data number k in i-th trial−explanatory variable of data number k

The processing is separated based on the sign of dD_{i,k}(l, j) for the following reason.

FIG. 20 shows an example of −ddA_{i,k}(l)dD_{i,k}(l, j) for the i-th trial and the k-th piece of data. The subset of the dimensions l (lowercase L) where −ddA_{i,k}(l)dD_{i,k}(l, j)>0 is denoted as l1, and the subset of dimensions l (lowercase L) where −ddA_{i,k}(l)dD_{i,k}(l, j)<0 is denoted as l2.

A situation is considered in which the number of elements in subset l1 is significantly small compared to subset l2. This corresponds to a case where effective variables are very few compared to the total number of variables.

In this case, the contribution of the extracted effective subset l1 becomes very small due to the larger subsets l2.

When the normalization is separated based on the sign of dD_{i,k}(l, j), the sum of contributions of subset l1=−the sum of contributions of subset l2. This emphases the contribution of the extracted effective variable l1.

1. An information selection system, comprising control circuitry that selects information to be used to create an analytical model, wherein
the control circuitry is configured to:
create multiple analytical models using a subset of pieces of information that include multiple pieces of training data, and calculate an accuracy of each of the analytical models;
assign a distribution value corresponding to each accuracy to pieces of information used to create the analytical models;
calculate a statistical value of the distribution value for each of the pieces of information used to create the analytical models; and
select, using the statistical values, information to be used to create the analytical models.

2. The information selection system according to claim 1, wherein the control circuitry is configured to select, as information to be used to create the analytical models, variables to be used to create the analytical models from explanatory variables included in the training data.

3. The information selection system according to claim 2, wherein the control circuitry is configured to:
predict explanatory variable values by inputting, as the training data, explanatory variable values of pieces of verification data to a self-organizing map created by using a data set in which the explanatory variable values and an objective variable value are combined;
calculate a contribution value of each of the explanatory variables by comparing the explanatory variable values of the pieces of verification data and the predicted explanatory variable values; and
calculate a distribution value corresponding to each accuracy using the contribution value.

4. The information selection system according to claim 2, wherein the control circuitry is configured to:
calculate a contribution value to a prediction result of an objective variable in prediction using the explanatory variables of the training data; and
assign, based on the contribution value, a distribution value corresponding to each accuracy to each explanatory variable.

5. The information selection system according to claim 4, wherein the control circuitry is configured to:
create, as each analytical model, a self-organizing map that includes nodes and paths using training data including objective variables and explanatory variables; and
calculate each contribution value from the prediction result of an objective variable that is predicted for the explanatory variables of the training data in the self-organizing map.

6. The information selection system according to claim 1, wherein the control circuitry is configured to select, as information to be used to create each analytical model, training data to be used to create the analytical model from the multiple pieces of training data.

7. An information selection method as a method for selecting information to be used to create an analytical model by using an information selection system including control circuitry, the information selection method comprising causing the control circuitry to:
create multiple analytical models using a subset of pieces of information that include multiple pieces of training data, and calculate an accuracy of each of the analytical models;
assign a distribution value corresponding to each accuracy to pieces of information used to create the analytical models;
calculate a statistical value of the distribution value for each of the pieces of information used to create the analytical models; and
select, using the statistical values, information to be used to create the analytical models.

8. A non-transitory computer-readable storage medium that stores an information selection program as a program for selecting information to be used to create an analytical model using an information selection system including control circuitry, the information selection program causing the control circuitry to perform operations comprising:
creating multiple analytical models using a subset of pieces of information that include multiple data sets, and calculating an accuracy of each of the analytical models;
assigning a distribution value corresponding to each accuracy to pieces of information used to create the analytical models;
calculating a statistical value of the distribution value for each of the pieces of information used to create the analytical models; and
selecting, using the statistical values, information to be used to create the analytical models.
